(19) United States
(12) Patent Application Publication
(10) Pub. No.: US 2018/0275988 A1
(43) Pub. Date: Sep. 27, 2018

(54) SOFTWARE DEVELOPMENT MANAGEMENTS

(71) Applicant: ENTIT SOFTWARE LLC, SANFORD, NC (US)

(72) Inventors: Daniel Shmaya, Yehud (IL); Itay Ben-Yehuda, Yehud (IL); Eliraz Busi, Yehud (IL)

(21) Appl. No.: 15/781,929

(22) PCT Filed: Dec. 9, 2015
(86) PCT No.: PCT/US2015/064667

§ 371 Date: Jun. 6, 2018

(51) Int. Cl. G06F 8/77

(52) U.S. Cl. CPC G06F 8/77

(57) ABSTRACT

Examples disclosed herein relate to software development managements. Some of the examples enable identifying a set of rules related to a software development methodology. Each rule of the set of rules may be associated with a rule-specific score. Some of the examples further enable monitoring a software development process, and determining, during the monitoring, whether at least one rule of the set of rules is invoked by an action performed by a user. If determined that a particular rule of the set of rules is invoked, a software development management score may be dynamically adjusted based on the rule-specific score associated with the particular rule. Some of the examples further enable providing a recommended action to increase the software development management score.

### BACKGROUND

Developing software programs is a complex process that involves problem definition, requirements development, design, coding and debugging, and unit testing, integration, and system testing and maintenance, for example. A variety of software development methodologies exist to structure, plan, and manage this process of software development. Examples of such software development methodologies include agile software development, waterfall, lean development, crystal method, dynamic systems development model (DSDM), extreme programming (XP), and feature driven development (FDD).

### BRIEF DESCRIPTION OF THE DRAWINGS

The following detailed description references the drawings, wherein:

FIG. 1 is a block diagram depicting an example environment in which various examples may be implemented as a software development managements system.

FIG. 2 is a block diagram depicting an example software development managements system.

FIG. 3 is a block diagram depicting an example machine-readable storage medium comprising instructions executable by a processor for software development managements.

FIG. 4 is a block diagram depicting an example machine-readable storage medium comprising instructions executable by a processor for software development managements.

FIG. 5 is a flow diagram depicting an example method for software development managements.

FIG. 6 is a flow diagram depicting an example method for software development managements.

### DETAILED DESCRIPTION

The following detailed description refers to the accompanying drawings. Wherever possible, the same reference numbers are used in the drawings and the following description to refer to the same or similar parts. It is to be expressly understood, however, that the drawings are for the purpose of illustration and description only. While several examples are described in this document, modifications, adaptations, and other implementations are possible. Accordingly, the following detailed description does not limit the disclosed examples. Instead, the proper scope of the disclosed examples may be defined by the appended claims.

Developing software programs is a complex process that involves problem definition, requirements development, design, coding and debugging, and unit testing, integration, and system testing and maintenance, for example. Because of this, many organizations rely on a well-defined software development methodology to structure, plan, and manage this process of software development. Examples of a software development methodology may include, but not being limited to, agile software development, waterfall, lean development, crystal method, dynamic systems development model (DSDM), extreme programming (XP), and feature driven development (FDD).

A particular software development methodology sets forth and/or requires a particular set of rules to be followed by a user and/or a team of users. A “user,” as used herein, may refer to an administrator, a programmer, a product owner, a business analyst, a customer, and/or any other users who engage in the software development process. Wrong implementations of the required rules, due to lack of experience or misunderstanding of the process, can reduce the velocity and quality of the development. Moreover, in large enterprise environments, it may be technically challenging to manage and track the development progress of multiple development teams and their improvements over time.

Examples disclosed herein provide technical solutions to these technical challenges by providing a comprehensive guiding tool that helps users to follow a set of rules required by a particular software development methodology to improve their compliance to the set of rules. Some of the examples enable identifying a set of rules related to a software development methodology. Each rule of the set of rules may be associated with a rule-specific score. Some of the examples further enable monitoring a software development process, and determining, during the monitoring, whether at least one rule of the set of rules is invoked by an action performed by a user. If determined that a particular rule of the set of rules is invoked, a software development management score may be dynamically adjusted based on the rule-specific score associated with the particular rule. Some of the examples further enable providing a recommended action to increase the software development management score.

The terminology used herein is for the purpose of describing particular embodiments only and is not intended to be limiting. As used herein, the singular forms “a,” “an,” and “the” are intended to include the plural forms as well, unless the context clearly indicates otherwise. The term “plurality,” as used herein, is defined as two or more than two. The term “another,” as used herein, is defined as at least a second or more. The term “coupled,” as used herein, is defined as connected, whether directly without any intervening elements or indirectly with at least one intervening elements, unless otherwise indicated. Two elements can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, third, etc. may be used herein to describe various elements, these elements should not be limited by these terms, as these terms are only used to distinguish one element from another unless stated otherwise or the context indicates otherwise. As used herein, the term “includes” means includes but not limited to, the term “including” means including but not limited to. The term “based on” means based at least in part on.

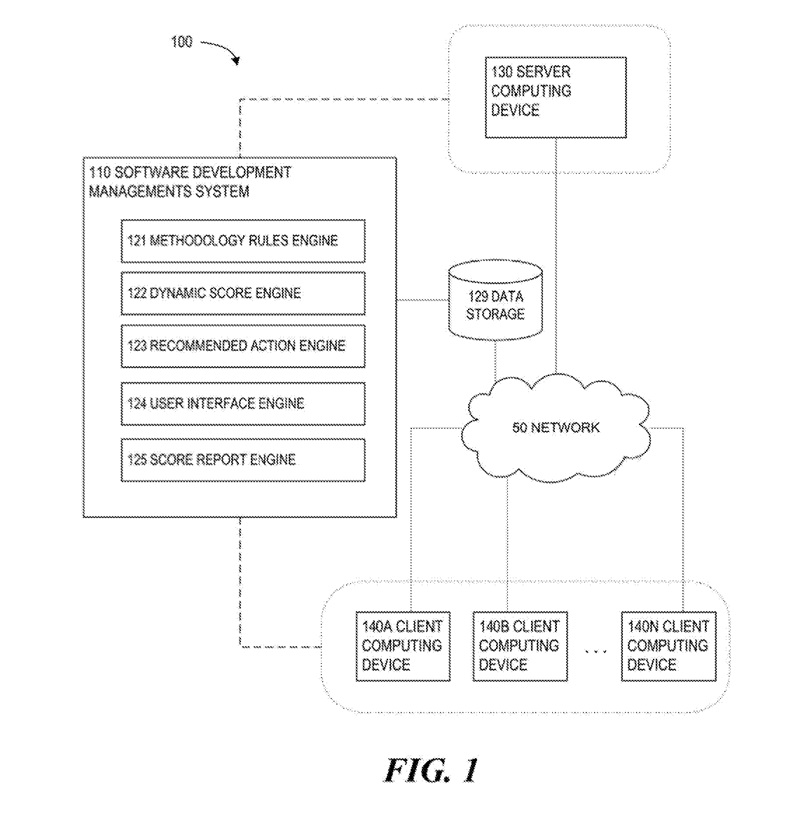

FIG. 1 is an example environment 100 in which various examples may be implemented as a software development managements system 110. Environment 100 may include various components including server computing device 130 and client computing devices 140 (illustrated as 140A, 140B, . . . , 140N). Each client computing device 140A, 140B, . . . , 140N may communicate requests to and/or receive responses from server computing device 130. Server computing device 130 may receive and/or respond to requests from client computing devices 140. Client computing devices 140 may be any type of computing device providing a user interface through which a user can interact with a software application. For example, client computing devices 140 may include a laptop computing device, a desktop computing device, an all-in-one computing device, a thin client, a workstation, a tablet computing device, a mobile phone, an electronic book reader, a network-enabled appliance such as a “Smart” television, and/or other electronic device suitable for displaying a user interface and processing user interactions with the displayed interface. While server computing device 130 is depicted as a single computing device, server computing device 130 may include any number of integrated or distributed computing devices serving at least one software application for consumption by client computing devices 140.

The various components (e.g., components 129, 130, and/or 140) depicted in FIG. 1 may be coupled to at least one other component via a network 50. Network 50 may comprise any infrastructure or combination of infrastructures that enable electronic communication between the components. For example, network 50 may include at least one of the Internet, an intranet, a PAN (Personal Area Network), a LAN (Local Area Network), a WAN (Wide Area Network), a SAN (Storage Area Network), a MAN (Metropolitan Area Network), a wireless network, a cellular communications network, a Public Switched Telephone Network, and/or other network. According to various implementations, software development managements system 110 and the various components described herein may be implemented in hardware and/or a combination of hardware and programming that configures hardware. Furthermore, in FIG. 1 and other Figures described herein, different numbers of components or entities than depicted may be used.

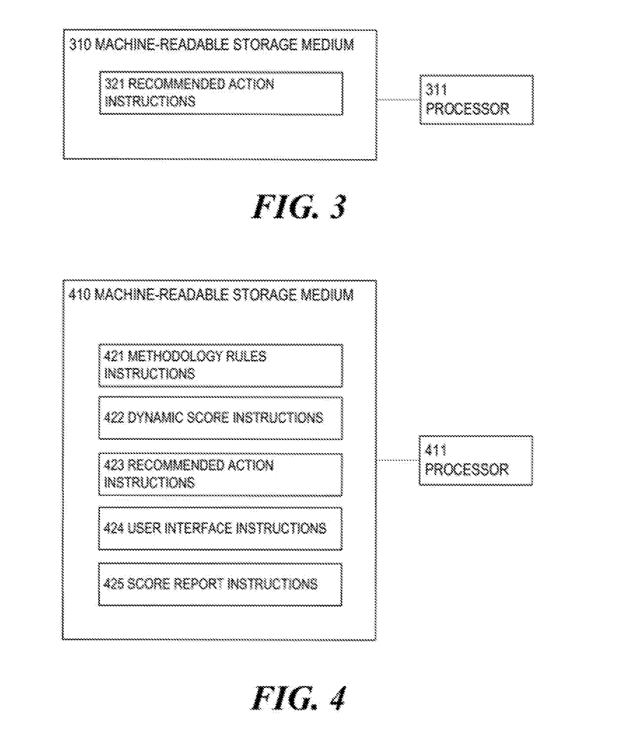

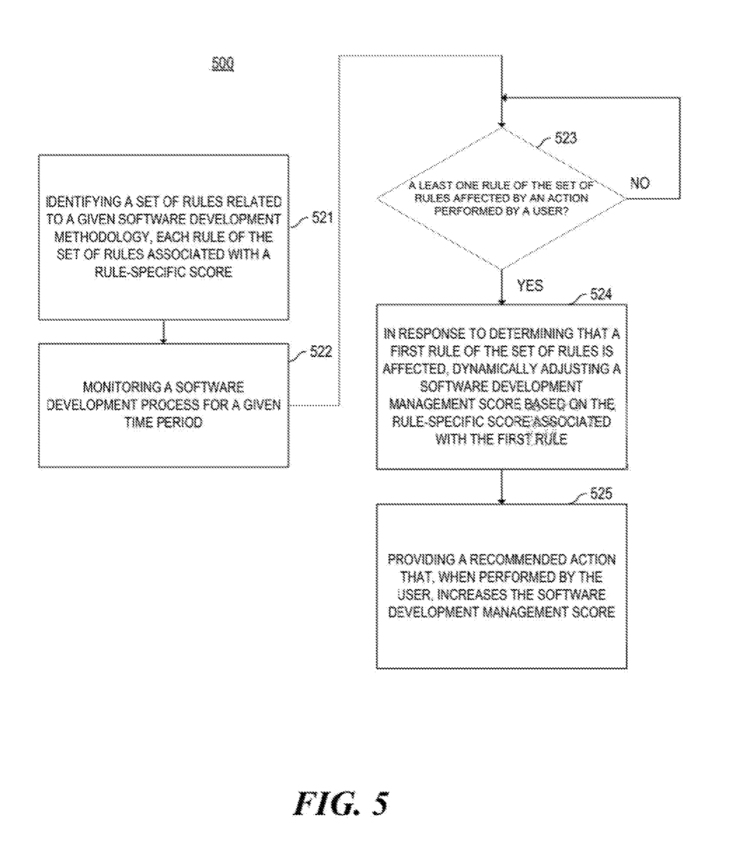

Software development managements system 110 may comprise a methodology rules engine 121, a dynamic score engine 122, a recommended action engine 123, a user interface engine 124, a score report engine 125, and/or other engines. The term “engine”, as used herein, refers to a combination of hardware and programming that performs a designated function. As is illustrated respect to FIGS. 3-4, the hardware of each engine, for example, may include one or both of a processor and a machine-readable storage medium, while the programming is instructions or code stored on the machine-readable storage medium and executable by the processor to perform the designated function.

Methodology rules engine 121 may identify a set of rules related to a software development methodology. As discussed above, a particular software development methodology sets forth and/or requires a particular set of rules to be followed by a user and/or a team of users. One example of software development methodology includes “waterfall” methodology. The waterfall methodology comprises several phases of development (e.g., requirements, analysis, design, coding, testing, acceptance, etc.) and is designed such that moving to the next phase of development requires the completion of the preceding phase. Development progress flows in a downward fashion; hence the name “waterfall” was conferred onto this model. The development phases, events, activities, actions, tasks, and/or items under each of the phases, and/or other rules may be defined as a set of rules associated with the waterfall methodology.

Another example of software development methodology includes “agile” methodology. This type of development is iterative and incremental (e.g., an iteration is called a “sprint” in scrum methodology, which is one type of agile methodology). In this methodology, the software is developed in small batches such that changes can be easily be introduced into the software product. In the example of scrum methodology, a product backlog refers to a list of product backlog items (PBIs) that are managed for any changes to be made to a particular software product. The product backlog may be used to capture requests for modifying a product (e.g., adding, replacing, and/or deleting features). Each PBI may be represented in the form of a user story that describes a desired feature in narrative form. In this case, a set of rules associated with the scrum methodology may include the following example rules: “a product backlog is defined before a sprint planning meeting,” “a new user story is not added to an active sprint,” “the number of defects that were opened during the sprint is less than a predefined threshold,” and “user stories are completed within a predefined timeframe.”

The set of rules related to a particular software development methodology may be identified in several ways: In some implementations, the set of rules may be pre-defined or otherwise provided by the particular software development methodology. The pre-defined set of rules may be obtained by methodology rules engine 121 and/or further defined and/or customized (e.g., a rule added, deleted, and/or modified) by a user. In other implementations, the set of rules may be manually defined by a user via methodology rules engine 121 by adding, deleting, and/or modifying any portion of the set of rules.

Each rule of the set of rules may be associated with a rule-specific score. The associated score may be given when the rule is invoked (e.g., satisfied or violated) by an action performed by a user (and/or an inaction by the user). A rule-specific score may be numerical (e.g., +5 points, −2 points, etc.), category-based (e.g., satisfied, violated, etc.), and/or of another form. Returning to the example above, the rule requiring that “a product backlog is defined before a sprint planning meeting” may be satisfied by a user's action of defining the product backlog before the sprint planning meeting, but may be violated if the user fails to define the product backlog before the sprint planning meeting. To encourage users to satisfy the rule, a positive rule-specific score (e.g., +3 points) may be associated with this rule, which may be given if the user satisfies the rule. In some implementations, another score may be associated with the same rule, which may be given if the user violates the rule. For example, a score of zero may be given if the user violates the rule, or in some situations, a negative score (e.g., −3 points) may be given.

In another example, the rule requiring that “a new user story is not added to an active sprint” may be violated if a user adds a new user story to an active sprint, but may remain satisfied if the user does not perform this action. To discourage users from violating the rule, a negative rule-specific score (e.g., −5 points) may be associated with this rule, which may be given if the user violates the rule. In some implementations, another score may be associated with the same rule, which may be given if the user does not violate the rule. For example, a score of zero may be given if the user does not violate the rule, or in some situations, a positive score (e.g., +1 point) may be given.

Such rule-specific scores may be pre-defined or otherwise provided by the particular software development methodology, and/or further defined and/or customized (e.g., score modified) by a user via methodology rules engine 121. In some implementations, a rule-specific score for a particular rule may be manually defined by a user via methodology rules engine 121.

Note that a different set of rules and/or different rule-specific scores may apply to different users (or teams). For example, a first user (or a first team) may be expected to comply with a first set of rules while a second user (or a second team) may be expected to comply with a second set of rules that is different from the first set of rules. In another example, both the first and second users (or the first and second teams) may be expected to comply with the same set of rules, but some rules may be associated with different scores for different users (or teams).

Dynamic score engine 122 may monitor a software development process. For example, dynamic score engine 122 may monitor actions performed by users (and/or their inactions) during the software development process. In some implementations, the monitoring may continue for a particular time period (e.g., a particular iteration, sprint, etc,). Dynamic score engine 122 may determine, during the monitoring, whether at least one rule of the set of rules (e.g., identified by methodology rules engine 121) is invoked (e.g., satisfied or violated) by an action performed by a user (and/or by an inaction of a user). For example, dynamic score engine 122 may, during the monitoring, detect that a new user story has been added to an active sprint by a user, and thus determine that the rule requiring that “a new user story is not added to an active sprint” has been invoked (e.g., violated) by the user's action.

Dynamic score engine 122 may determine and/or dynamically adjust a software development management score based on which rules of the set of rules are invoked. A “software development management score,” as used herein, may indicate a measure of compliance with a set of rules associated with a particular software development methodology. A software development management score may represent a measure of compliance by a user and/or a team of users. In some instances, a software development management score may be determined for the particular time period for which the monitoring took place. In this way, a software development management score determined for a user (or a team of users) may be easily compared with a software development management score determined for another user (or another team of users). Moreover, a software development management score determined for one iteration or sprint may be compared to a software development management score determined for another iteration or sprint.

For example, if a first rule of the set of rules is invoked, the rule-specific score associated with the first rule may be added to and/or subtracted from the software development management score. Similarly, if a second rule of the set of rules is invoked, the rule-specific score associated with the second rule may be added to and/or subtracted from the software development management score.

Recommended action engine 123 may identify a current status of the software development process (e.g., as being monitored by dynamic score engine 122). A “current status of the software development process,” as used herein, may comprise information related to: current progress or rate thereof (e.g., a percentage of software development being completed to date, a percentage of software development completed per a unit of time such as 10% completion per week); current development work distribution, current status of development tasks (e.g., user stories) completed, yet to be completed, delayed, etc., current development team membership, and/or any other information related to the software development process.

Recommended action engine 123 may use the current status to determine a recommended action to increase the software development management score. For example, the recommended action, if performed by a user, may increase the software development management score. If the current status indicates that “user stories are not assigned equally among the sprint members” (e.g., one of the set of rules may require the user stories to be assigned equally among the sprint members), the recommended action may be generated to suggest the user to move certain user stories to one member to another member.

In some implementations, recommended action engine 123 may determine which rules of the set of rules are predicted to be violated based on the current status. Recommended action engine 123 may generate an alert message that notifies the user of the rules that are predicted to be violated and/or provide a recommended action that, if performed by a user, satisfies at least one of the rules that are predicted to be violated. For example, this determination (of which rules of the set of rules are predicted to be violated) may be based on projecting the current progress rate forward. Consider the following example: a particular rule of the set of rules is defined that 100% content should be delivered until the end of the 8-week long sprint. Recommended action engine 123 may identify the current status (e.g., at the 4-week mark, 40% of the content is completed) and/or the current progress rate (e.g., 10% completion per week). Recommended action engine 123 may then determine that the particular rule is predicted to be violated (e.g., meaning that 100% content cannot be delivered until the end of the sprint) given the current status (e.g., given that the current progress rate is projected forward). If the current progress rate is projected forward, another 40% of the content can be completed over the next 4 weeks, resulting in 80% completion rather than 100% completion that was originally intended by the particular rule. Note that the rule that is predicted to be violated may be satisfied by performance of a recommended action.

In some implementations, the recommended action may be provided in narrative form. For example, it may state “user stories are not assigned equally among the sprint members. You can increase your score by 5 points by moving 2 user stories from Daniel to Jack.” Note that this may include the recommended action (e.g., moving 2 user stories from Daniel to Jack), a current status and/or a rule to be satisfied by the recommended action (e.g., user stories are not assigned equally among the sprint members), and a rule-specific score associated with the rule to be satisfied by the recommended action (e.g., 5 points).

A recommended action may be tailored to a particular user (e.g., different users may have a different set of recommended actions, the same recommended action in different narrative form, etc.) and/or to a particular development team.

User interface engine 124 may present, via a user interface, the software development management score, a recommended action, a current status and/or a rule to be satisfied by the recommended action, a rule-specific score associated with the rule to be satisfied by the recommended action (e.g., an increase in the software development management score if the recommended action is performed by the user), etc. In some examples, if a cursor pointer hovers over a graphical user element representing the software development management score, user interface engine 124 may cause a display of the recommended action (e.g., moving 2 user stories from Daniel to Jack), a current status and/or a rule to be satisfied by the recommended action (e.g., user stories are not assigned equally among the sprint members), and/or a rule-specific score associated with the rule to be satisfied by the recommended action (e.g., 5 points).

In this way, if a user (e.g., development team lead) is dissatisfied with the current software development management score, the user may easily receive several recommended actions to increase the level of compliance with the set of rules imposed by the given software development methodology.

Score report engine 125 may generate a score report that includes a detailed breakdown of the software development management score. The report may include rules that have been invoked, rule-specific scores associated with those invoked rules, any statistics related to the software development process (e.g., overall development progress rate), recommended actions by recommended action 123, recommended actions that have been performed by a user, and/or other information related to the software development process and/or software development methodology.

In performing their respective functions, engines 121-125 may access data storage 129 and/or other suitable database(s). Data storage 129 may represent any memory accessible to software development managements system 110 that can be used to store and retrieve data. Data storage 129 and/or other database may comprise random access memory (RAM), read-only memory (ROM), electrically-erasable programmable read-only memory (EEPROM), cache memory, floppy disks, hard disks, optical disks, tapes, solid state drives, flash drives, portable compact disks, and/or other storage media for storing computer-executable instructions and/or data. Software development managements system 110 may access data storage 129 locally or remotely via network 50 or other networks.

Data storage 129 may include a database to organize and store data. The database may reside in a single or multiple physical device(s) and in a single or multiple physical location(s). The database may store a plurality of types of data and/or files and associated data or file description, administrative information, or any other data.

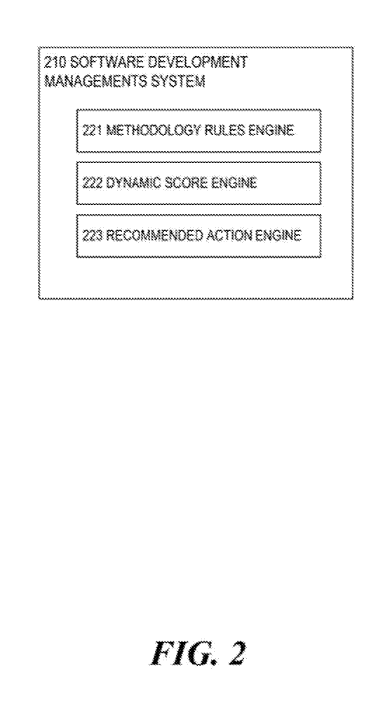

FIG. 2 is a block diagram depicting an example software development managements system 210. Software development managements system 210 may comprise a methodology rules engine 221, a dynamic score engine 222, a recommended action engine 223, and/or other engines. Engines 221-223 represent engines 121-123, respectively.

FIG. 3 is a block diagram depicting an example machine-readable storage medium 310 comprising instructions executable by a processor for software development managements.

In the foregoing discussion, engines 121-125 were described as combinations of hardware and programming. Engines 121-125 may be implemented in a number of fashions. Referring to FIG. 3, the programming may be processor executable instructions 321 stored on a machine-readable storage medium 310 and the hardware may include a processor 311 for executing those instructions. Thus, machine-readable storage medium 310 can be said to store program instructions or code that when executed by processor 311 implements software development managements system 110 of FIG. 1.

In FIG. 3, the executable program instructions in machine-readable storage medium 310 are depicted as recommended action instructions 321. Instructions 321 represent program instructions that, when executed, cause processor 311 to implement engines 123, respectively.

FIG. 4 is a block diagram depicting an example machine-readable storage medium 410 comprising instructions executable by a processor for software development managements.

Referring to FIG. 4, the programming may be processor executable instructions 421-425 stored on a machine-readable storage medium 410 and the hardware may include a processor 411 for executing those instructions. Thus, machine-readable storage medium 410 can be said to store program instructions or code that when executed by processor 411 implements software development managements system 110 of FIG. 1.

In FIG. 4, the executable program instructions in machine-readable storage medium 410 are depicted as methodology rules instructions 421, dynamic score instructions 422, recommended action instructions 423, user interface instructions 424, and score report instructions 425. Instructions 421-425 represent program instructions that, when executed, cause processor 411 to implement engines 121-125, respectively.

Machine-readable storage medium 310 (or machine-readable storage medium 410) may be any electronic, magnetic, optical, or other physical storage device that contains or stores executable instructions. In some implementations, machine-readable storage medium 310 (or machine-readable storage medium 410) may be a non-transitory storage medium, where the term “non-transitory” does not encompass transitory propagating signals. Machine-readable storage medium 310 (or machine-readable storage medium 410) may be implemented in a single device or distributed across devices. Likewise, processor 311 (or processor 411) may represent any number of processors capable of executing instructions stored by machine-readable storage medium 310 (or machine-readable storage medium 410). Processor 311 (or processor 411) may be integrated in a single device or distributed across devices. Further, machine-readable storage medium 310 (or machine-readable storage medium 410) may be fully or partially integrated in the same device as processor 311 (or processor 411), or it may be separate but accessible to that device and processor 311 (or processor 411).

In one example, the program instructions may be part of an installation package that when installed can be executed by processor 311 (or processor 411) to implement software development managements system 110. In this case, machine-readable storage medium 310 (or machine-readable storage medium 410) may be a portable medium such as a floppy disk, CD, DVD, or flash drive or a memory maintained by a server from which the installation package can be downloaded and installed. In another example, the program instructions may be part of an application or applications already installed. Here, machine-readable storage medium 310 (or machine-readable storage medium 410) may include a hard disk, optical disk, tapes, solid state drives, RAM, ROM, EEPROM, or the like.

Processor 311 may be at least one central processing unit (CPU), microprocessor, and/or other hardware device suitable for retrieval and execution of instructions stored in machine-readable storage medium 310. Processor 311 may fetch, decode, and execute program instructions 321, and/or other instructions. As an alternative or in addition to retrieving and executing instructions, processor 311 may include at least one electronic circuit comprising a number of electronic components for performing the functionality of at least one of instructions 321, and/or other instructions.

Processor 411 may be at least one central processing unit (CPU), microprocessor, and/or other hardware device suitable for retrieval and execution of instructions stored in machine-readable storage medium 410. Processor 411 may fetch, decode, and execute program instructions 421-425, and/or other instructions. As an alternative or in addition to retrieving and executing instructions, processor 411 may include at least one electronic circuit comprising a number of electronic components for performing the functionality of at least one of instructions 421-425, and/or other instructions.

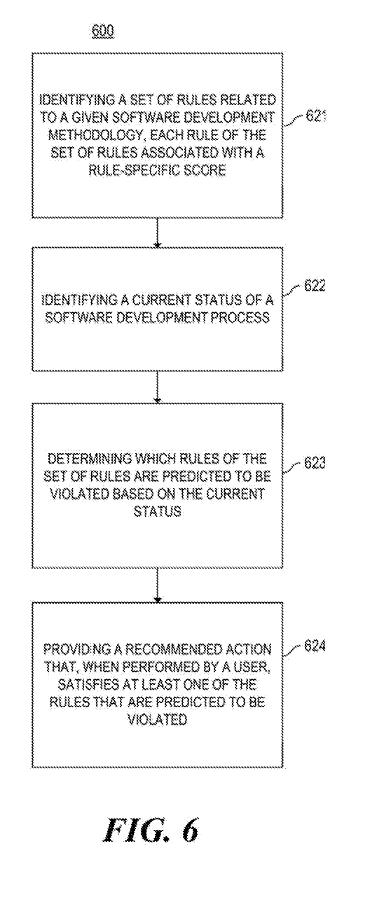

FIG. 5 is a flow diagram depicting an example method 500 for software development managements. The various processing blocks and/or data flows depicted in FIG. 5 (and in the other drawing figures such as FIG. 6) are described in greater detail herein. The described processing blocks may be accomplished using some or all of the system components described in detail above and, in some implementations, various processing blocks may be performed in different sequences and various processing blocks may be omitted. Additional processing blocks may be performed along with some or all of the processing blocks shown in the depicted flow diagrams. Some processing blocks may be performed simultaneously. Accordingly, method 500 as illustrated (and described in greater detail below) is meant to be an example and, as such, should not be viewed as limiting. Method 500 may be implemented in the form of executable instructions stored on a machine-readable storage medium, such as storage medium 310, and/or in the form of electronic circuitry.

In block 521, method 500 may include identifying a set of rules related to a software development methodology. Each rule of the set of rules may be associated with a rule-specific score. Referring back to FIG. 1, methodology rules engine 121 may be responsible for implementing block 521.

In block 522, method 500 may include monitoring a software development process. Referring back to FIG. 1, dynamic score engine 122 may be responsible for implementing block 522.

In block 523, method 500 may include determining, during the monitoring, whether at least one rule of the set of rules is invoked by an action performed by a user. In response to determining that a first rule of the set of rules is affected, method 500 may proceed to block 524. Otherwise, method 500 may return to block 522. Referring back to FIG. 1, dynamic score engine 122 may be responsible for implementing block 523.

In block 524, method 500 may include dynamically adjusting a software development management score based on the rule-specific score associated with the first rule. Referring back to FIG. 1, dynamic score engine 122 may be responsible for implementing block 524.

In block 525, method 500 may include providing a recommended action to increase the software development management score. Referring back to FIG. 1, recommended action engine 123 may be responsible for implementing block 525.

FIG. 6 is a flow diagram depicting an example method 600 for software development managements. Method 600 as illustrated (and described in greater detail below) is meant to be an example and, as such, should not be viewed as limiting. Method 600 may be implemented in the form of executable instructions stored on a machine-readable storage medium, such as storage medium 310, and/or in the form of electronic circuitry.

In block 621, method 600 may include identifying a set of rules related to a software development methodology. Each rule of the set of rules may be associated with a rule-specific score. Referring back to FIG. 1, methodology rules engine 121 may be responsible for implementing block 621.

In block 622, method 600 may include identifying a current status of a software development process. Referring back to FIG. 1, recommended action engine 123 may be responsible for implementing block 622.

In block 623, method 600 may include determining which rules of the set of rules are predicted to be violated based on the current status. Referring back to FIG. 1, recommended action engine 123 may be responsible for implementing block 623.

In block 624, method 600 may include providing a recommended action that, when performed by a user, satisfies at least one of the rules that are predicted to be violated. Referring back to FIG. 1, recommended action engine 123 may be responsible for implementing block 624.

The foregoing disclosure describes a number of example implementations for software development managements. The disclosed examples may include systems, devices, computer-readable storage media, and methods for software development managements. For purposes of explanation, certain examples are described with reference to the components illustrated in FIGS. 1-4. The functionality of the illustrated components may overlap, however, and may be present in a fewer or greater number of elements and components.

Further, all or part of the functionality of illustrated elements may co-exist or be distributed among several geographically dispersed locations. Moreover, the disclosed examples may be implemented in various environments and are not limited to the illustrated examples. Further, the sequence of operations described in connection with FIGS. 5-6 are examples and are not intended to be limiting. Additional or fewer operations or combinations of operations may be used or may vary without departing from the scope of the disclosed examples. Furthermore, implementations consistent with the disclosed examples need not perform the sequence of operations in any particular order. Thus, the present disclosure merely sets forth possible examples of implementations, and many variations and modifications may be made to the described examples. All such modifications and variations are intended to be included within the scope of this disclosure and protected by the following claims.

1. A method for software development managements, the method comprising:
identifying a set of rules related to a software development methodology, each rule of the set of rules associated with a rule-specific score;
monitoring a software development process;
determining, during the monitoring, whether at least one rule of the set of rules is invoked by an action performed by a user;
in response to determining that a first rule of the set of rules is invoked, dynamically adjusting a software development management score based on the rule-specific score associated with the first rule; and
providing a recommended action to increase the software development management score.

2. The method of claim 1, further comprising:
in response to determining that a second rule of the set of rules is invoked, dynamically adjusting the software development management score based on the rule-specific score associated with the second rule.

3. The method of claim 1, further comprising:
identifying a current status of the software development process; and
determining which rules of the set of rules are predicted to be violated based on the current status.

4. The method of claim 3, further comprising:
generating an alert message that notifies the user of the rules that are predicted to be violated.

5. The method of claim 3, further comprising:
providing the recommended action that, if performed by the user, satisfies at least one of the rules that are predicted to be violated.

6. The method of claim 1, wherein the software development methodology comprises: agile software development, waterfall, lean development, crystal method, dynamic systems development model (DSDM), extreme programming (XP), or feature driven development (FDD).

7. A non-transitory machine-readable storage medium comprising instructions executable by a processor of a computing device for software development managements, the machine-readable storage medium comprising:
instructions to identify a current status of a software development process that is managed using a software development methodology, the software development methodology having a set of rules, the current status including information related to a current progress rate;
instructions to determine which rules of the set of rules are predicted to be violated, the determination being based on projecting the current progress rate forward; and
instructions to generate a recommended action that, if performed by a first user of a first software development team, avoids violation of at least one of the rules that are predicted to be violated.

8. The non-transitory machine-readable storage medium of claim 7, further comprising:
instructions to monitor the software development process for a first time period;
instructions to determine, during the monitoring, whether a first rule of the set of rules is invoked by an action performed by a second user of the first software development team, the first rule associated with a first rule-specific score;
in response to determining that the first rule is invoked, dynamically adjusting a software development management score based on the first rule-specific score; and
instructions to provide the recommended action to increase the software development management score.

9. The non-transitory machine-readable storage medium of claim 8, further comprising:
instructions to provide a comparison between the software development management score associated with the first software management team and a software development management score associated with a second software management team.

10. The non-transitory machine-readable storage medium of claim 8, further comprising:
instructions to provide a comparison between the software development score determined for the first time period and a software development score determined for a second time period.

11. The non-transitory machine-readable storage medium of claim 7, wherein the set of rules comprises at least one of: a first set of positive rules and a second set of negative rules, each positive rule of the first set associated with a positive score and each negative rule of the second set associated with a negative score.

12. A system for software development managements comprising:
a processor that:
identifies a set of rules related to a software development methodology, each rule of the set of rules associated with a rule-specific score;
monitors a software development process;
determines, during the monitoring, whether at least one rule of the set of rules is invoked by an action performed by a user;
in response to determining that a first rule of the set of rules is invoked, dynamically adjusts a software development management score based on the rule-specific score associated with the first rule; and
identifies a current status of the software development process; and
determines a recommended action based on the current status, wherein the recommended action, if performed by the user, increases the software development management score.

13. The system of claim 12, the processor that:
presents, via a user interface, the software development management score, the recommended action, and an increase in the software development management score if the recommended action is performed by the user.

14. The system of claim 12, the processor that:
In response to determining that a second rule of the set of rules is invoked, dynamically adjusts the software development management score based on the rule-specific score associated with the second rule; and
generates a score report that includes the first rule, the rule-specific score associated with the first rule, the second rule, and the rule-specific score associated with the second rule.

15. The system of claim 12, the processor that:
monitors the software development process for a time period, wherein the time period comprises an iteration or a sprint.
